(19) United States
(12) Patent Application Publication
(10) Pub. No.: US 2005/0219503 A1
(43) Pub. Date: Oct. 6, 2005

(54) Object detecting apparatus having reinforcing member

(76) Inventors: Yoshiki Adachi, Okazaki-city (JP); Takekazu Terui, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/093,838

(22) Filed: Mar. 30, 2005

(30) Foreign Application Priority Data
Mar. 31, 2004 (JP) 2004-104121

(51) Int. Cl. G01C 3/08; G01S 13/08

(52) U.S. Cl. 356/4.01; 342/118; 356/5.01

(57) ABSTRACT

An object detecting apparatus emits a detecting wave to the outside, and receives the detecting wave reflected from an object. The object detecting apparatus includes a case that accommodates a wave-emitting device, which emits the detecting wave, and a wave-receiving device, which receives the detecting wave reflected from the obstacle. A projection window and an entrance window, which are formed of a material transmitting the detecting wave, are provided to the case. The detecting wave emitted from the wave-emitting device passes through the projection window. The detecting wave is reflected from the obstacle, and is received by the wave-receiving device after passing through the entrance window. A reinforcing member, which is formed of a material that transmits the detecting wave, is arranged in front of the projection window and the entrance window.

### CROSS REFERENCE TO RELATED APPLICATIONS

This application is based on and incorporates herein by reference Japanese Patent Applications No. 2004-104121 filed on Mar. 31, 2004.

### FIELD OF THE INVENTION

The present invention relates to an object detecting apparatus. More particularly, the present invention relates to a distance detecting apparatus that is mounted on a vehicle to detect distance from a vehicle, which runs ahead of the driver's vehicle, using electromagnetic wave such as lightwave.

### BACKGROUND OF THE INVENTION

Conventionally, a laser radar is used as a distance detecting apparatus mounted on a vehicle to detect distance from an obstacle such as a vehicle ahead of the driver's vehicle using laser or the like. The object detecting apparatus intermittently radiates laser from a laser diode to an obstacle ahead of the driver's vehicle, and detects reflection from the obstacle using a photo sensor. The object detecting apparatus measures distance from the obstacle ahead of the driver's vehicle based on time difference between the radiation of laser and the detection of reflection of the laser.

Specifically, the object detecting apparatus includes a light-emitting device, a polygonal mirror, and a light-receiving device. The light-emitting device emits laser. The polygonal mirror is in a substantially hexagonal-pyramid shape. The polygonal mirror is rotatably provided to reflect laser emitted by the light-emitting device. The light-receiving device receives laser reflected from the polygonal mirror. Thus, laser emitted by the light-emitting device is reflected from the polygonal mirror, and the reflected laser is introduced to the ahead of the vehicle in the above structure. The polygonal mirror is rotated such that each of the lateral faces of the polygonal mirror reflects laser emitted by the light-emitting device, so that a reflection angle, by which the polygonal mirror reflects laser, is adjusted. Thus, the laser is capable of being scanned in a predetermined area ahead of the vehicle. Laser, which is reflected from an obstacle ahead of the vehicle, is received by the light-receiving device, so that distance from the obstacle is measured, according to JP-A-2002-031685, for example.

The object detecting apparatus is used in a vehicle that is in a harsh environment. Accordingly, components such as a scanning device, an optical device, and an electronic device are accommodated in a sealed case, so that the components are protected from foreign matters such as debris and condensation of moisture. The object detecting apparatus includes a projection window and an entrance window that are translucent. Laser emitted from the light-emitting device is radiated to the outside of the case through the projection window. Laser reflected from an obstacle is received by the light-receiving device through the entrance window.

However, the projection window and the entrance window are respectively formed of a glass plate or an acrylic plate in the above structure. Accordingly, the projection window and the entrance window may be broken, when an object makes contact with the projection window and the entrance window. In this case, the object detecting apparatus may cause a failure.

### SUMMARY OF THE INVENTION

In view of the foregoing problems, it is an object of the present invention to produce an object detecting apparatus that has a structure, in which a projection window and an entrance window are protected, so that the object detecting apparatus is capable of being protected from causing a failure due to damage of the projection window and the entrance window.

According to the present invention, an object detecting apparatus emits a detecting wave to the outside, and receives the detecting wave reflected from the outside to detect an object. The object detecting apparatus includes a case, a wave-emitting device, a projection window, a wave-receiving device, an entrance window, and a reinforcing member. The wave-emitting device is accommodated in the case. The wave-emitting device emits the detecting wave. The projection window is provided to the case. The projection window is formed of a material that transmits the detecting wave. The detecting wave, which is emitted from the wave-emitting device, passes through the projection window. The wave-receiving device is accommodated in the case. The wave-receiving device receives the detecting wave, which is reflected from the obstacle. The entrance window is provided to the case. The entrance window is formed of a material that transmits the detecting wave. The detecting wave is received by the wave-receiving device after passing through the entrance window. The reinforcing member is arranged in front of the projection window and the entrance window. The reinforcing member is formed of a material that transmits the detecting wave. The reinforcing member covers the projection window and the entrance window.

The detecting wave is an electromagnetic wave, laser or the like.

The wave-emitting device emits the detecting wave to the outside of the case through the projection window and the reinforcing member. The wave-receiving device receives the detecting wave reflected from the outside of the case through the reinforcing member and the entrance window to detect the object.

The object detecting apparatus further includes a control means that detects the object in accordance with the detecting wave received by the wave-receiving device. Specifically, the control means calculates distance from the obstacle, which reflects the detecting wave, in accordance with the detecting wave received by the wave-receiving device.

The wave-emitting device, the projection window, and the reinforcing member are arranged in order in the direction, in which the detecting wave is emitted. The reinforcing member, the entrance window, and the wave-receiving device are arranged in order in the direction in which the detecting wave is emitted.

The reinforcing member is a laminated grass. The reinforcing member is detachable from the case. The reinforcing member is fixed to the case via an outer periphery of the projection window and an outer periphery of the entrance window.

The projection window of the case has slide grooves on both sides thereof. The entrance window of the case has slide grooves on both sides thereof. The reinforcing member is inserted into the slide grooves.

Each slide groove has an upper portion that is capable of elastically deforming. The laminated grasses are detachable from the slide grooves through the upper portion of the slide grooves.

### BRIEF DESCRIPTION OF THE DRAWINGS

The above and other objects, features and advantages of the present invention will become more apparent from the following detailed description made with reference to the accompanying drawings. In the drawings:

FIG. 1 is a front view showing an object detecting apparatus according to a first embodiment of the present invention;

FIG. 2 is a side view showing the object detecting apparatus according to the first embodiment;

FIG. 2 is a partially cross sectional side view showing the object detecting apparatus according to the first embodiment; and

FIG. 4A is a perspective view showing the object detecting apparatus to which a laminated glasses are being assembled, FIG. 4B is a front view showing the object detecting apparatus to which the laminated glass are assembled, and FIG. 4C is a side view showing the object detecting apparatus to which the laminated glass are assembled, according to the first embodiment.

### DETAILED DESCRIPTION OF PREFERRED EMBODIMENTS

### First Embodiment

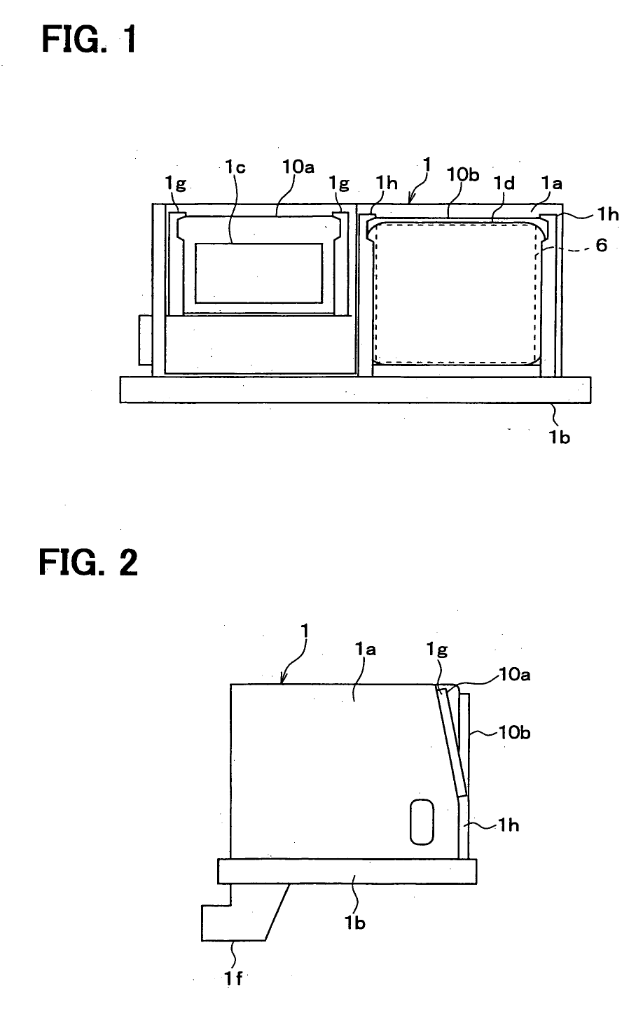

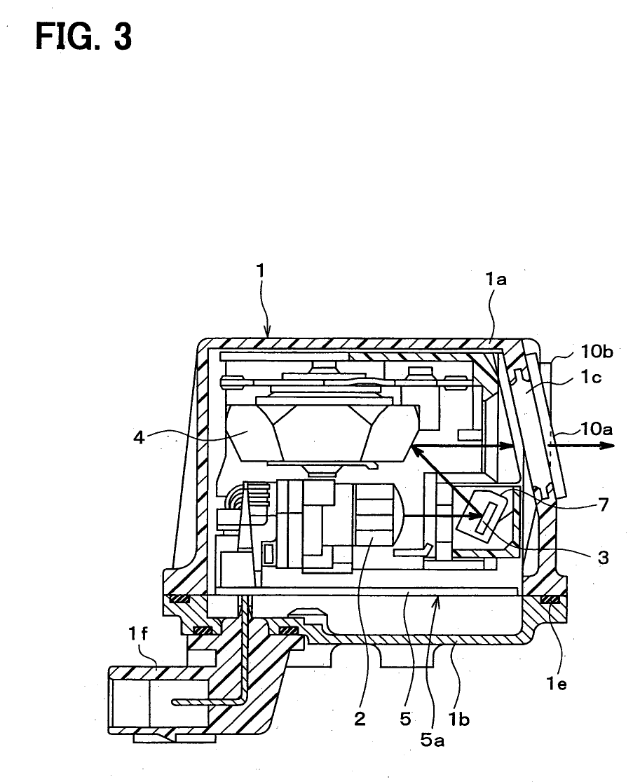

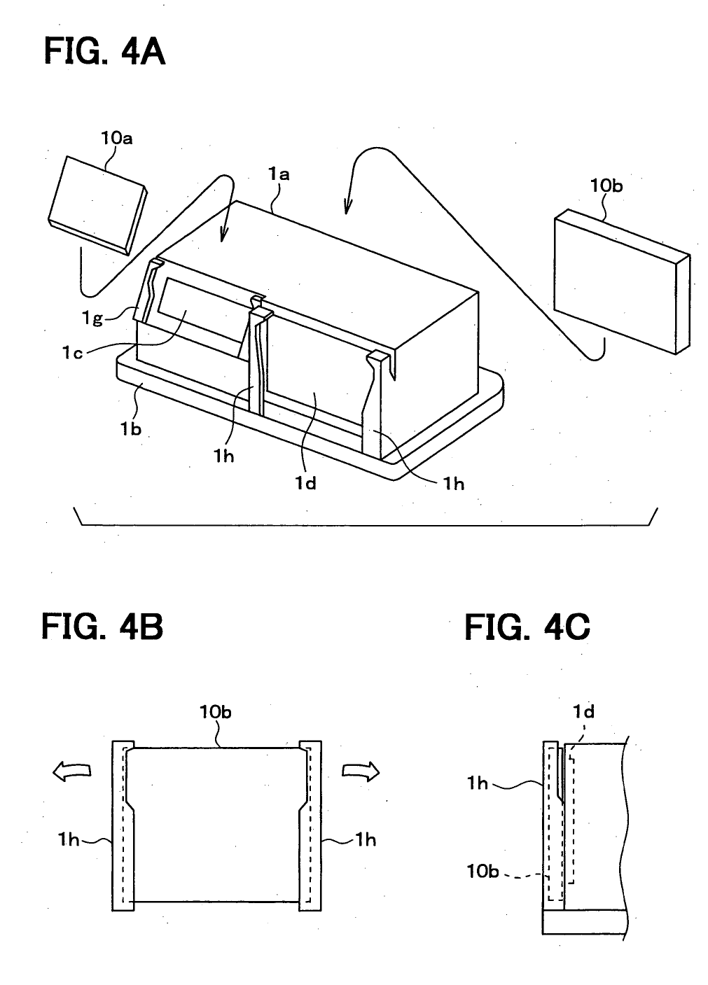

As shown in FIGS. 1 to 3, an object detecting apparatus such as a distance detecting apparatus is mounted in a vehicle. The right portion of the object detecting apparatus in FIGS. 2, 3 is directed to the ahead of the vehicle, so that the object detecting apparatus is used as a laser radar. The laser radar measures distance between the driver's vehicle and an obstacle such as a vehicle running ahead of the driver's vehicle in an auto cruise mode, for example.

The distance detecting apparatus has a case 1 that is formed of resin in a substantially cubic shape to accommodate components.

The case 1 is constructed of a first case la and a second case 1b. The first case 1a is in a box shape that is opened in one plane. The first case 1a defines an accommodating space that receives various components. The first case 1a is formed of a unitary resinous material, in principle. A projection window 1c and an entrance window 1d are laterally arranged in a plane of the first case 1a, which is directed ahead of the vehicle. The projection window 1c and the entrance window 1d are formed of a translucent material such as grass or acrylic resin. That is, the projection window 1c and the entrance window 1d are formed of a material that is capable of transmitting a detecting wave such as laser.

As shown in FIG. 1, laminated grasses 10a, 10b are respectively arranged in front of the projection window 1c and the entrance window 1d. The laminated grasses 10a, 10b are respectively constructed of resinous films that are laminated between multiple grasses made of sodium carbonate grass, and the resinous films and the multiple grasses are rigidly bonded together, for example. Even when the laminated grasses 10a, 10b are shattered to be fragments, the fragments of the laminated grasses 10a, 10b are not apt to be scattered. Besides, the laminated grasses 10a, 10b are hard to be penetrated. Strength of the laminated grasses 10a, 10b is higher than strength of both the projection window 1c and the entrance window 1d. Each of the laminated grasses 10a, 10b serves as a reinforcing member.

The laminated grass 10a is slightly greater than the projection window 1c. The laminated grass 10b is slightly greater than the entrance window 1d. Slide grooves 1g are formed on both sides of the projection window 1c, and slide grooves 1h are formed on both sides of the entrance window 1d in the first case 1a.

Excessive portions of the laminated grass 10a with respect to the projection window 1c are received in the slide grooves 1g, and excessive portions of the laminated grass 10b with respect to the entrance window 1d are received in the slide grooves 1h. That is, the outer peripheries of the laminated grasses 10a, 10b are received in the slide grooves 1g, 1h.

Specifically, the upper portions of the slide grooves 1g, 1h are capable of being elastically widened to the outside. The laminated grasses 10a, 10b are respectively inserted into the slide grooves 1g, 1h, while the upper portions of the slide grooves 1g, 1h are elastically widened. The laminated grasses 10a, 10b are respectively inserted into the slide grooves 1g, 1h, and subsequently, the slide grooves 1g, 1h are restored to be in an original shapes by elasticity of the slide grooves 1g, 1h. Thus, the upper portions of the slide grooves 1g, 1h serve as hooks to support the laminated grasses 10a, 10b within the slide grooves 1g, 1h.

The laminated grasses 10a, 10b may respectively contact with the projection window 1c and the entrance window 1d. However preferably, the laminated grasses 10a, 10b are respectively maintained not to closely make contact with the projection window 1c and the entrance window 1d to form predetermined gaps therebetween, for example. A translucent resinous film may be arranged between the laminated grass 10a and the projection window 1c, and a translucent resinous film may be arranged between the laminated grass 10b and the entrance window 1d. In this structure, the laminated grasses 10a, 10b may respectively closely make contact with the projection window 1c and the entrance window 1d via the translucent resinous films.

A second case 1b is formed of resin, for example. As shown in FIG. 3, the second case 1b is assembled to the opening plane of the first case 1a via a sealing member 1e.

A connector 1f is provided to the second case 1b such that the connector 1f partially protrudes from the case 1. The components inside the case 1 can be electrically connected with components outside the case 1 via the connector 1f.

The components such as a light-emitting device (wave-emitting device) 2, a reflecting mirror 3, a polygonal mirror 4, a substrate 5 are accommodated in the case 1. The substrate 5 includes a control device-(control means) 5a that controls the object detecting apparatus. As referred to FIG. 1, a light-receiving device (wave-receiving device) 6 is accommodated in the case 1 such that the light-receiving device 6 opposes to the entrance window 1d.

As referred to FIG. 3, the light-emitting device 2 is operated in accordance with a signal transmitted from the control device 5a provided to the substrate 5 such that the light-emitting device 2 radiates laser to the reflecting mirror 3.

The reflecting mirror 3 reflects laser radiated from the light-emitting device 2, so that the laser is radiated to the polygonal mirror 4. The reflecting mirror 3 is rotatably supported by a supporting portion 7, which is secured to the inner wall of the case 1. A motor is operated by the control device 5a of the substrate 5, so that the motor rotates the reflecting mirror 3 along an axis that is vertical with respect to the plane of the paper of FIG. 3. The motor rotates the reflecting mirror 3 to perform fine adjusting of a reflection angle, e.g., adjusting the reflection angle by one degree.

The polygonal mirror 4 is in a hexagonal-pyramid shape, in which the tip end of the hexagonal-pyramid is cut off. The polygonal mirror 4 is supported rotatably with respect to the axis thereof on the upper side in the case 1. The polygonal mirror 4 is rotated by a motor (not shown) that is operated by the control device 5a provided to the substrate 5. Each lateral surface of the polygonal mirror 4 serves as a reflecting mirror, specifically a scanning mirror.

More specifically, laser is emitted from the light-emitting device 2, and the laser is reflected from the reflecting mirror 3. The polygonal mirror 4 further reflects the laser reflected from the reflecting mirror 3, so that the polygonal mirror 4 introduces the laser ahead of the vehicle through the projection window 1c of the first case 1a. The motor rotates the polygonal mirror 4, so that the angle of lateral surface of the polygonal mirror 4 is changed in accordance with rotation of the polygonal mirror 4. Thereby, a projection angle of the laser reflected from the polygonal mirror 4 is changed, so that a predetermined range ahead of the vehicle can be scanned.

As referred to FIG. 1, the light-receiving device 6 is constructed of a Fresnel lens, a light-receiving element, and the like. The light-receiving element is constructed of a photo diode or the like.

The Fresnel lens converges laser, and the converged laser is radiated to the light-receiving element, so that the light-receiving element generates current or voltage in accordance with a degree of the laser, which is received by the light-receiving element. Thus, the light-receiving device 6 detects laser radiated to the upper side of the case 1. The current or voltage generated by the light-receiving device 6 is input to the control device 5a of the substrate 5 shown in FIG. 3.

The light-receiving device 6 is arranged laterally with respect to the polygonal mirror 4. That is, the light-receiving device 6 is vertically shifted with respect to the rotation axis of the polygonal mirror 4.

Next, an operation of the object detecting apparatus is described.

The object detecting apparatus, i.e., distance detecting apparatus having the above structure measures distance from a vehicle ahead of the driver's vehicle, when a switch, which is provided in a passenger compartment, is turned ON to activate an auto cruise control operation, for example.

A motor is operated in accordance with a signal transmitted from the control device 5a, so that the angle of the reflecting mirror 3 is adjusted at a predetermined angle. Laser is radiated from the light-emitting device 2 at a predetermined timing, and the laser is reflected from the reflecting mirror 3 and the polygonal mirror 4, so that the laser is radiated to a vehicle ahead of the driver's vehicle through the projection window 1c. When the laser is reflected from the vehicle ahead of the driver's vehicle, the reflected laser passes through the entrance window 1d, and the laser is converged through the Fresnel lens. Thus, the converged laser is radiated to the light-receiving element.

Thereby, the light-emitting element generates current or voltage in accordance with the degree of the laser received by the light-emitting element. The current or voltage generated in the light-emitting element is detected by the control device 5a. The control device 5a calculates distance D from the vehicle ahead of the driver's vehicle in accordance with time difference T between timing, in which laser is radiated, and timing, in which the laser is detected, using the following formula (1). That is, the control device 5a calculates the distance D in accordance with time difference T of input of laser and the velocity V of the laser, using the following formula (1).
velocity (V)×time difference (T)/2 (1)

Thus, the distance D between the driver's car and the car ahead of the driver's car is calculated, and an output signal corresponding to the calculated distance D is transmitted from the control device 5a to components outside of the case 1, such as the ECU for the engine and an ECU for a brake via the connector if. Thereby, engine power or breaking force is controlled such that the distance D is maintained at a constant distance.

Next, an effect of the object detecting apparatus is described.

The laminated grasses 10a, 10b are respectively arranged in front of the projection window 1c and the entrance window 1d in the above object detecting apparatus. Thereby, the projection window 1c and the entrance window 1d are covered with and protected by the laminated grasses 10a, 10b. Therefore, even when an object such as a stepping-stone hits the object detecting apparatus, the laminated grasses 10a, 10b may be damaged instead of the projection window 1c and the entrance window 1d. Thus, the object detecting apparatus is capable of being protected from causing a failure due to damage of the projection window 1c and the entrance window 1d.

Besides, when the laminated grasses 10a, 10b are damaged, cracking occurs over the laminated grasses 10a, 10b in a web-shape, so that damage of the laminated grasses 10a, 10b can be emphasized. Laser reflects diffusely over the portion of the laminated grasses 10a, 10b damaged in a web shape. Thereby, damage of the laminated grasses 10a, 10b can be detected as well as soil adhering on the laminated grasses 10a, 10b, when the object detecting apparatus has a function for detecting soil adhering on the projection window 1c.

When the object detecting apparatus has a system structure, in which a system failure of the object detecting apparatus is indicated using an indicating device such as an alert lamp and a liquid crystal display, damage of the laminated grasses 10a, 10b can be notified to the driver using the indicating device.

The laminated grasses 10a, 10b are easily detachable from the slide grooves 1g, 1h by elastically deforming the upper portions of the slide grooves 1g, 1h. A maintenance work can be performed by replacing the laminated grasses 10a, 10b, so that maintainability is enhanced in the above structure.

### Other Embodiment

The laminated grasses 10a, 10b may be supported using other structure than the above structure. For example, glue may be painted on both sides of the projection window 1c, and glue may be painted on both sides of the entrance window 1d of the resinous portion of the first case 1a, so that the laminated grasses 10a, 10b may be secured to the resinous portion of the first case 1a via the glue.

In this structure, glue, which can be easily dissolved using solvent, may be used as the glue securing the laminated grasses 10a, 10b to the resinous portion (outer periphery) of the first case 1a. Thereby, the laminated grasses 10a, 10b can be easily removed from the first case 1a by dissolving the glue.

The laminated grasses 10a, 10b are easily detachable from the slide grooves 1g, 1h by dissolving the glue. A maintenance work can be performed by replacing the laminated grasses 10a, 10b, so that maintainability is enhanced in the above structure.

The structure to support the laminated grasses 10a, 10b may be any structures using a screw, a pin, a spring, and the like.

Another plate member such as a tempered glass can be used as a reinforcing member instead of the laminated grasses.

The above structure can be applied to an object detecting apparatus that uses an electromagnetic wave such as a submillimeter wave instead of using lightwave such as laser for detecting an object. That is, the above structure can be applied to any detecting apparatus that radiates an electromagnetic wave from an electromagnetic wave projecting portion, and receives the electromagnetic wave, which is reflected from an object, through an electromagnetic wave receiving portion to detect existence of the object. The object detecting apparatus using an electromagnetic wave may be applied to a distance detecting apparatus.

Arrangement of components constructing the object detecting apparatus is not limited to the above arrangement. The structure of the present invention can be applied to an object detecting apparatus having any other arrangements of components.

The object detecting apparatus having the above structure is not limited to be applied to the distance detecting apparatus. The object detecting apparatus may be applied to other detecting apparatus such as a proximity switch and the like.

Various modifications and alternations may be diversely made to the above embodiments without departing from the spirit of the present invention.

1. An object detecting apparatus that emits a detecting wave to an outside, the object detecting apparatus that receives the detecting wave reflected from the outside to detect an object, the object detecting apparatus comprising:
a case;
a wave-emitting device that is accommodated in the case, the wave-emitting device that emits the detecting wave;
a projection window that is provided to the case, the projection window that is formed of a material, which transmits the detecting wave, wherein the detecting wave emitted from the wave-emitting device passes through the projection window;
a wave-receiving device that is accommodated in the case, the wave-receiving device that receives the detecting wave reflected from the obstacle;
an entrance window that is provided to the case, the entrance window that is formed of a material, which transmits the detecting wave, wherein the detecting wave is received by the wave-receiving device after passing through the entrance window; and
a reinforcing member that is arranged in front of the projection window and the entrance window,
wherein the reinforcing member is formed of a material that transmits the detecting wave, and
the reinforcing member covers the projection window and the entrance window.

2. The object detecting apparatus according to claim 1, wherein the detecting wave is an electromagnetic wave.

3. The object detecting apparatus according to claim 1, wherein the detecting wave is a lightwave.

4. The object detecting apparatus according to claim 1,
wherein the wave-emitting device emits the detecting wave to an outside of the case through the projection window and the reinforcing member, and
the wave-receiving device receives the detecting wave reflected from the outside of the case through the reinforcing member and the entrance window to detect the object.

5. The object detecting apparatus according to claim 1, further comprising:
a control means that detects the object in accordance with the detecting wave received by the wave-receiving device.

6. The object detecting apparatus according to claim 1, further comprising:
a control means that calculates distance from the obstacle, which reflects the detecting wave, in accordance with the detecting wave received by the wave-receiving device.

7. The object detecting apparatus according to claim 1,
wherein the wave-emitting device, the projection window, and the reinforcing member are arranged in order in a direction in which the detecting wave is emitted, and
the reinforcing member, the entrance window, and the wave-receiving device are arranged in order in a direction in which the detecting wave is emitted.

8. The object detecting apparatus according to claim 1, wherein the reinforcing member is a laminated grass.

9. The object detecting apparatus according to claim 1, wherein the reinforcing member is detachable from the case.

10. The object detecting apparatus according to claim 1, wherein the reinforcing member is fixed to the case via an outer periphery of the projection window and an outer periphery of the entrance window.

11. The object detecting apparatus according to claim 1,
wherein the projection window of the case has slide grooves on both sides thereof,
the entrance window of the case has slide grooves on both sides thereof, and
the reinforcing member is inserted into the slide grooves.

12. The object detecting apparatus according to claim 11,
wherein each slide groove has an upper portion that is capable of elastically deforming, and
the laminated grasses are detachable from the slide grooves through the upper portion of the slide grooves.
